(19) United States
(12) Patent Application Publication
(10) Pub. No.: US 2020/0180026 A1
(43) Pub. Date: Jun. 11, 2020

(54) APPARATUS AND METHOD FOR ADDATIVE MANUFACTURING

(71) Applicant: GE AVIATION SYSTEMS LLC, Grand Rapids, MI (US)

(72) Inventors: Nader D. Dariavach, Lake Worth, FL (US); Michel Engelhardt, Woodbury, NY (US)

(21) Appl. No.: 16/704,455

(22) Filed: Dec. 5, 2019

Related U.S. Application Data
(60) Provisional application No. 62/776,107, filed on Dec. 6, 2018.

(51) Int. Cl. B22F 3/105

(52) U.S. Cl. CPC B22F 3/1055; B22F 2003/1056; B33Y 10/00; B22F 2301/052; B22F 2201/02; B22F 2302/105

(57) ABSTRACT

A method of fabricating and apparatus for additive manufacturing including an environmental chamber defining an interior, a platform on which the object is built in a powder bed within the interior of the environmental chamber, a supply of nitrogen coupled to the interior of the environmental chamber, a laser creating an ion channel extending to the powder, and a power source applying electrical energy to the ion channel, the electrical energy being transmitted through the ion channel to the powder in the powder bed.

### CROSS REFERENCE TO RELATED APPLICATION(S)

This application claims priority to and benefit of U.S. Provisional Patent Application No. 62/776,107 filed Dec. 6, 2018, which is incorporated herein in its entirety.

### TECHNICAL FIELD

The disclosure relates to a method and apparatus for fabricating an object by additive manufacturing.

### BACKGROUND

Additive manufacturing processes generally involve the buildup of one or more materials to make an object, in contrast to subtractive manufacturing methods, which remove material. Additive manufacturing can be utilized to form a variety of components having both simple and intricate geometries.

### BRIEF DESCRIPTION

In one aspect, the disclosure relates to a method of fabricating an object by additive manufacturing including providing a molecule rich environment, creating a laser induced plasma channel in the molecule rich environment to a portion of powder in a powder bed, and applying electrical energy to the laser induced plasma channel, wherein the electrical energy is transmitted through the laser induced plasma channel to the powder in the powder bed, wherein energy from at least the electrical energy melts or sinters the portion of the powder in the powder bed

In another aspect the disclosure relates to an apparatus for additive manufacturing including an environmental chamber defining an interior, a powder bed within the interior of the environmental chamber, a supply of gas selectively fluidly coupled to the interior of the environmental chamber, an irradiation source irradiating a portion of powder in the powder bed, the irradiation creating an ion channel extending to the powder, and a power source applying electrical energy to the ion channel, the electrical energy being transmitted through the ion channel to the powder in the powder bed.

In yet another aspect, the disclosure relates to a cooling module including a metal base plate and an aluminum silicon carbide metal matrix composite heat spreader unitarily formed with at least a portion of the metal base plate and where the aluminum silicon carbide metal matrix composite heat spreader is configured to be operably coupled to a heat generating electronic device.

### BRIEF DESCRIPTION OF THE DRAWINGS

In the drawings:

FIG. 1 is a perspective view of an aircraft having an electronics chassis in accordance with various aspects described herein.

FIG. 2 is a perspective view of an exemplary power module that can be included in the electronics chassis of FIG. 1 in accordance with various aspects described herein.

FIG. 3 is a cross-sectional view of the power module of FIG. 2 along the line

FIG. 4 is a schematic illustration of an additive manufacturing apparatus according to aspects described herein.

FIG. 5 is a schematic illustration of additive manufacturing with the apparatus of FIG. 4 according to aspects described herein.

### DETAILED DESCRIPTION

Aspects of the present disclosure relate to additive manufacturing; specifically, applying an electric pulse through a laser induced plasma channel (LIPC), or “ion channel, for use in a three-dimensional metal printing process. Aspects of the present disclosure can be utilized for, among other things, a method of manufacturing a heat spreader such as for use in an electronics chassis or power module for use in an aircraft or for any metal and non-metal part including non-homogeneous metal and non-metal parts. Aspects of the present disclosure also relate to, among other things, forming an aluminum silicon carbide (AL Sic) Metal Matrix Composite (MMC) through a LIPC induced by an ultraviolet (UV) laser beam in a pressurized nitrogen enriched environment.

Generally, a freestanding object can be fabricated from a computer aided design (CAD) model during additive manufacturing. Laser sintering or melting is one type of additive manufacturing process for rapid fabrication of functional prototypes, parts and tools. Selective laser sintering, direct laser sintering, selective laser melting, and direct laser melting are common industry terms used to refer to producing three-dimensional objects by using a laser beam to sinter or melt a fine powder. Sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process is complex. This method of fabrication is accompanied by multiple modes of transient heat, mass and momentum transfer, and chemical reactions that make the process complex. Current selective laser melting three-dimensional printing processes have many disadvantages when compared with standard manufacturing processes. These disadvantages include, for example, reduced strength due to non-complete sintering of metal powder particles, which is common for additive manufacturing processing, and high levels of residual stresses due to highly concentrated localized heat application. Other disadvantages pertain to porosity issues, which have recently been observed in the development of cold plates used to cool high power electronic power conversion products that provide thermal management to silicon carbide electronic components.

In addition, the problems associated with present additive manufacturing processes using infrared lasers or direct lasers are that multiple phase transformations and complex microstructures often result in thermal residual stresses. Rapid heating and cooling rates (AT-1,000 to 100,000 K/s) result in suppressed phase transformations, supersaturated phases, segregation, hot cracking, and thermal residual stresses. Direct metal laser melting and other such processes have a low efficiency of approximately 25% or less due to the direct use of a laser to produce the melting of particles. The unidirectional heat flow into the building plate or substrate results in textured grains and anisotropic properties. Every layer undergoes repeated heating and cooling cycles, which results in temperatures that can exceed Tliq or Tα←β. Current infrared lasers used in additive manufacturing are therefore inefficient to produce complex metal parts. An increase in heating is needed along with a more rapid manufacturing process. The aspects of the present disclosure innovation produces value by increasing the heating efficiency of lasers used in additive manufacturing by introducing an electric pulse through a LIPC. In addition, this innovation is focused on an advanced LIPC technology by creating the LIPC using an ultra-violet (UV) laser in a high-pressure nitrogen atmosphere. It will be understood that aspects of the present disclosure can be utilized in combination with conventional infrared selective laser sintering or as a standalone process.

While “a set of” various elements will be described, it will be understood that “a set” can include any number of the respective elements, including only one element. It is also understood that the gas used for conducting the electrical pulse is not limited to nitrogen and can constitute other gases or gas mixtures whose molecules can be excited by a laser beam. Additionally, all directional references (e.g., radial, axial, upper, lower, upward, downward, left, right, lateral, front, back, top, bottom, above, below, vertical, horizontal, clockwise, counterclockwise) are only used for identification purposes to aid the reader's understanding of the disclosure, and do not create limitations, particularly as to the position, orientation, or use thereof. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order, and relative sizes reflected in the drawings attached hereto can vary.

It will be understood that while a cooling module is disclosed for illustrative purposes of the manufacturing process and its applicability it will be understood that the process can be utilized for additively manufacturing any suitable large or smaller objects, such as but not limited to components, or layers thereon, of an aircraft engine, or, for that matter, any homogeneous or non-homogeneous metal or non-metal part for any application (non-limiting examples include parts for electric power generation, medical systems/components, optical imaging, electronics, automobiles, space system part fabrication, etc.). Further still, while this cooling module can have general applicability, the environment of an aircraft and specific application of an avionics chassis and electrical assembly will be described in further detail. Aircraft avionics have increasing demands and higher power density in a smaller space and have therefore seen increasing requirements of power dissipating devices. New power generation units, conversion units, or transistors can have requirements for new materials and more efficient electrical and thermal management.

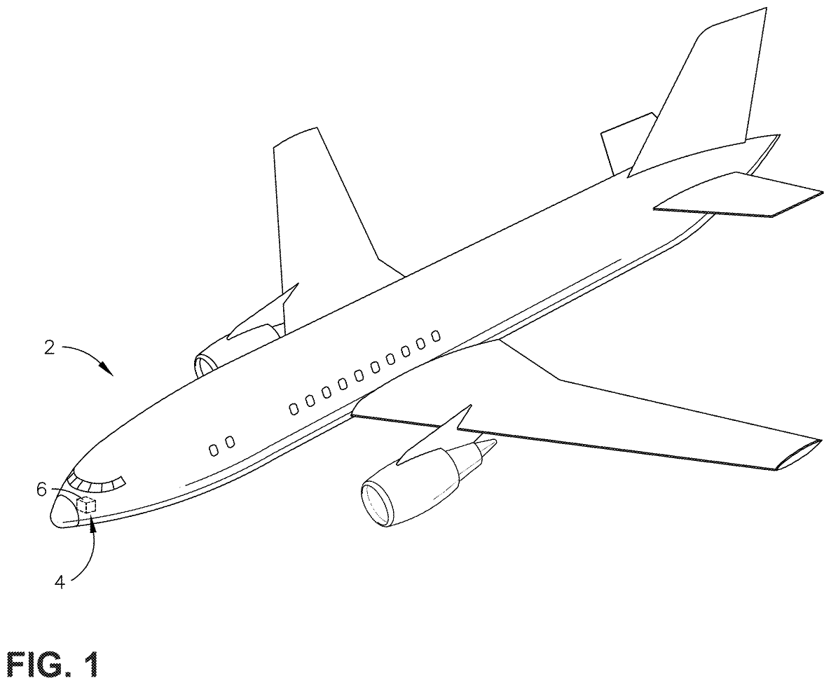

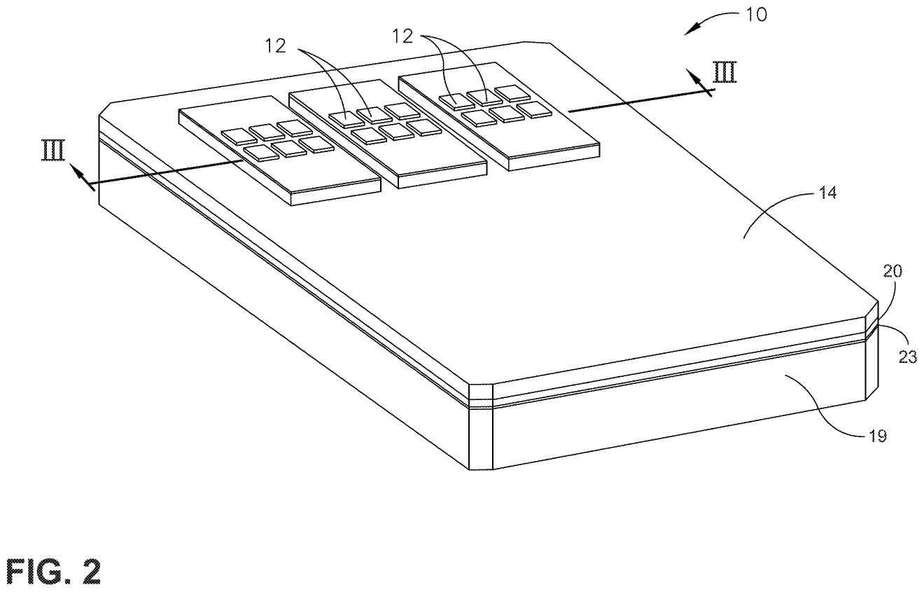

FIG. 1 schematically illustrates an aircraft 2 with an avionics system 4, illustrated as an on-board electronics chassis 6 (shown in phantom) for housing avionics or avionic components for use in the operation of the aircraft 2. It will be understood that the avionics system 4 can include a thermal management member having heat spreaders, heat sinks, heat exchangers, radiators, or heat pipes in non-limiting examples. The electronics chassis 6 can house a variety of power modules 10 (FIG. 2) for avionics electronic devices and protects against contaminants, electromagnetic interference (EMI), radio frequency interference (RFI), vibrations, and the like. Alternatively or additionally, the electronics chassis 6 can have a variety of avionics mounted thereon. It will be understood that the electronics chassis 6 can be located anywhere within the aircraft 2, not just the nose as illustrated. While illustrated in a commercial airliner, the electronics chassis 6 and power module 10 can be used in any type of aircraft, for example, without limitation, fixed-wing, rotating-wing, rocket, commercial aircraft, personal aircraft, and military aircraft. Furthermore, aspects of the disclosure are not limited only to aircraft aspects, and can be included in other mobile and stationary configurations. Non-limiting example mobile configurations can include ground-based, water-based, or additional air-based vehicles as well as electric power generation, medical systems/components, optical imaging, electronics, automobiles, ships, submarines, space system part fabrication, etc.

FIG. 2 is a power module 10 including a set of electronic devices 12, a substrate 14, and a base plate 18 according to aspects of the present disclosure. The power module 10 can be located in the electronics chassis 6 (FIG. 1). In an aspect of the disclosure, non-limiting examples of the electronic device 12 can include insulated gate bipolar Transistors (IGBT), metal oxide semiconductor field effect transistors (MOSFET), diodes, metal semiconductor field effect transistors (MESFET), and high electron mobility transistors (HEMT) used for applications not limited to avionics applications, automotive applications, oil and gas applications, or the like. According to aspects of the disclosure herein, the electronic device 12 can be manufactured from a variety of semiconductors, non-limiting examples of which include silicon, silicon carbide, gallium nitride, and gallium arsenide. The electronic device 12 can generate heat during operation.

The substrate 14 can be provided to avoid electrical short circuits and to perform heat exchange between a cooling module 19 and the electronic device 12. In an aspect of the disclosure herein, the substrate 14 is an electrically isolating and thermally conductive layer, such as a ceramic layer. Non-limiting examples of the ceramic layer can include aluminum oxide, aluminum nitride, beryllium oxide, and silicon nitride. In one non-limiting example, the cooling module 19 can be directly bonded to the substrate 14. The substrate 14 can be coupled to the cooling module 19 and the electronic device 12 using a number of techniques, including but not limited to, brazing, bonding, diffusion bonding, soldering, or pressure contact such as clamping to provide a simple assembly process. It should be noted herein that the exemplary arrangements described with respect to the power module 10 and cooling module 19 are for illustrative purposes only and not meant to be limiting.

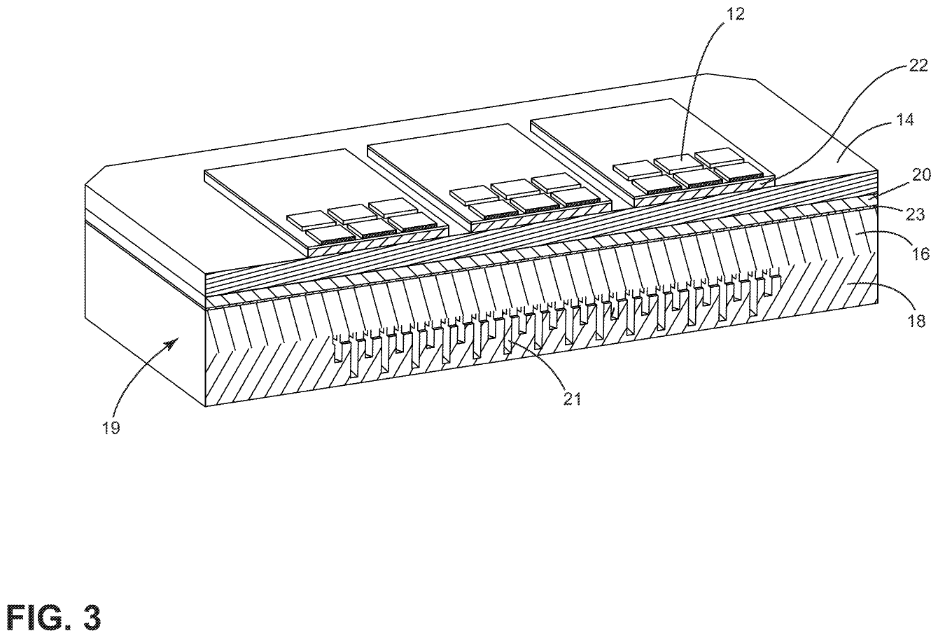

FIG. 3 is a cross-sectional view and more clearly illustrates that the heat generating component of the electronic device 12 can be bonded to the substrate 14 via a first conductive layer 22. Further still, the substrate 14 can be bonded to a thermal pad 23 via a second conductive layer 20. The first conductive layer 22 and second conductive layer 20 can be any suitable layers including by way of non-limiting example copper layers. In another aspect of the disclosure herein, an aluminum layer, a gold layer, a silver layer, or an alloy layer can be preferred instead of copper layers.

It will be understood that the thermal pad 23 can be optional. The optional thermal pad 23 can include a thermally conductive material, such as a carbon composite, a metal, or a thermally conductive paste, and can be positioned in thermally conductive contact such that heat can be conducted therethrough. Regardless of inclusion of the thermal pad 23, the power module 10 can be mounted to the cooling module 19 to direct heat away from the electronic device(s) 12.

By way of non-limiting example, a base plate 18 and heat spreader 16 are illustrated as being included in the cooling module 19. In the illustrated example, the base plate 18 is a liquid cooled base plate that is operably coupled to the thermal pad 23 in any suitable manner. At least one cooling manifold is provided within the base plate 18 and includes a plurality of channels 21 that intersect to create spaced cavities through which a cooling fluid (not shown) can flow during operation. Multiple channels 21 are shown and are connected to each other to form a cooling channel circuit in the base plate 18. Other structures (not illustrated) such as internal heat transfer fins can also be included within the channel 21. A flow of cooling fluid through the base plate 18 can be controlled as desired and will not be explained herein. The cooling fluid can be any suitable cooling fluid, by way of non-limiting example a mixture of propylene glycol, ethylene glycol, fuel, oil, refrigerants, and water as well as other coolants. Accordingly, when the electronic device 12 is operably coupled on the cooling module 19, the cooling fluid flowing through the channels 21 of the base plate 18 provides cooling of the electronic device 12.

The heat spreader 16 forms a portion of the cooling module 19 and is illustrated as being integrally formed with the base plate 18. The heat spreader 16 can be any suitable heat spreader including that it can be a MMC that can include, but is not limited to, aluminum, copper, aluminum SiC (AlSiC), or aluminum-graphite. As shown by the cross-section, the manner in which the heat spreader 16 contacts the base plate 18 enables direct cooling to the heat spreader 16 from cooling fluid within the channels 21 of the base plate 18, although this need not be the case. The remainder of the disclosure will focus on the heat spreader 16 being an AlSiC MMC heat spreader. Such a heat spreader 16 formed from an AlSiC MMC will have a coefficient of thermal expansion that is much more compatible with the substrate 14 of the power module 10 and will minimize coefficient of thermal expansion mismatch. It is beneficial to use an AlSiC material because the AlSiC material has a low coefficient of thermal expansion and it has conduction heat transfer properties that are slightly below that of aluminum. AlSiC is also a good replacement for ceramic substrates.

It will be understood that conventional three-dimensional laser sintering of MMCs is not feasible and machining is currently very expensive using diamond tooling. The disadvantage of the current manufacturing processes is in the difficulty to machine these parts. This is because silicon carbide particles are highly abrasive and require the application of diamond cutters. In addition, machine operations are expensive and limited. Also, the bonding of dissimilar materials cannot be accomplished in a cost-effective way.

Aspects of the disclosure relate to a SiC MMC layer, including an AlSiC MMC layer, produced by the LIPC additive manufacturing method being deposited on the top of the aluminum liquid cooled base plate 18. Such process is cost effective and provides the ability to manufacture complex shapes.

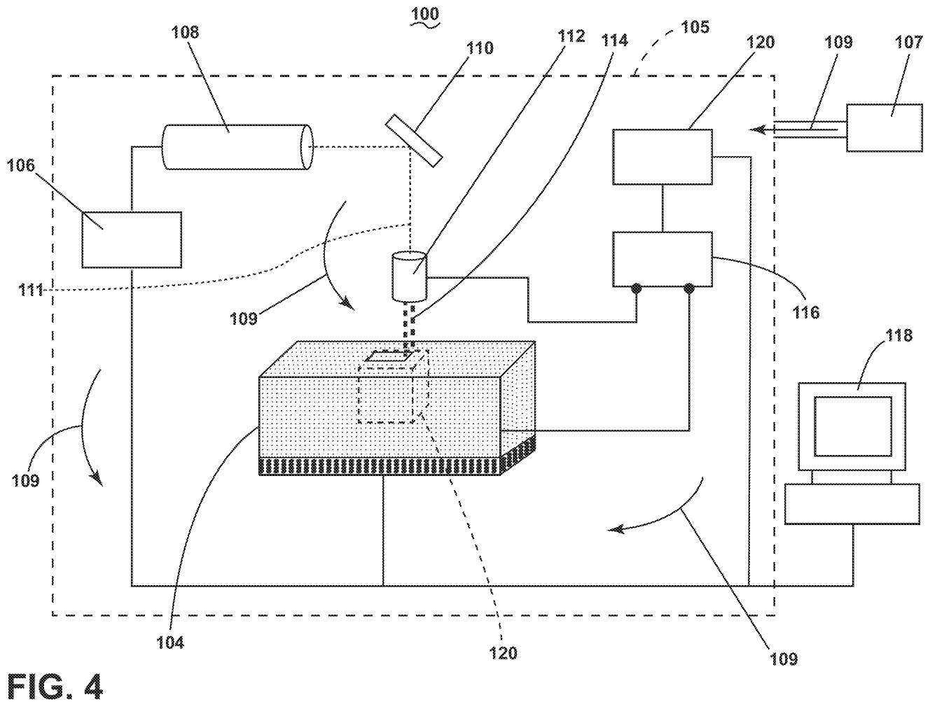

FIG. 4 is an illustration of an additive manufacturing apparatus 100 according to aspects of the present disclosure, which can be utilized to build a part 102 layer-by-layer in a powder bed 104 within a controlled environment 105. The powder bed 104 can be fed by a powder dispenser (not shown). It will be understood that the controlled environment 105 can be any suitable closed manufacturing configuration configured to be controlled in any suitable manner. Herein the controlled environment 105 is sealable and configured to remain pressurized. A pressurized nitrogen supply 107 is selectively fluidly coupled with the controlled environment 105 and is configured to provide nitrogen 109, illustrated schematically with arrows, into the controlled environment 105. Any suitable valve or control mechanism (not shown) can be included to control the supply and pressurization thereof.

The part 102 may be built by using a laser power supply 106. The laser power supply 106 supplies power to an ultraviolet laser 108 that emits a beam to mirror 110. The beam reflects off the mirror 110 to a focusing lens 112. The focusing lens 112 may be, for example, an optical lens to focus and transmit the energy of the laser beam emitted by the ultraviolet laser 108.

The apparatus 100 also includes a power supply 116 to provide an electric pulse to the focusing lens 112. The laser power supply 106 and the power supply 116 may be connected to a functional generator 120 and controlled by a programmable controller or controller 118. The controller 118 may be, for example, a programmable proportional, integral, differential controller that provides dual laser and electrical power pulse control.

According to an aspect, during operation, nitrogen 109 is introduced via the nitrogen supply 107 into the controlled environment 105 until the internal pressure is increased. By way of non-limiting example, nitrogen 109 can be supplied until the internal pressure has increased by 30 psi and maintained thereat during the forming process. The power supply 116 is then controlled so that the ultraviolet laser 108 emits a laser beam 111 into a volume of air space above the powder bed 104. The laser beam 111 emitted by the ultraviolet laser 108 rapidly excites and ionizes surrounding gases, including the supplied nitrogen 109 and forms an ionization path to guide the electric pulses provided by the power supply 116. The ionized surrounding gases form plasma which forms an electrically conductive uniform plasma channel 114. The electric pulses provided by the power supply 116 may then be applied through the plasma channel 114 to heat and bond metal powder in the powder bed 104 to build the part 102.

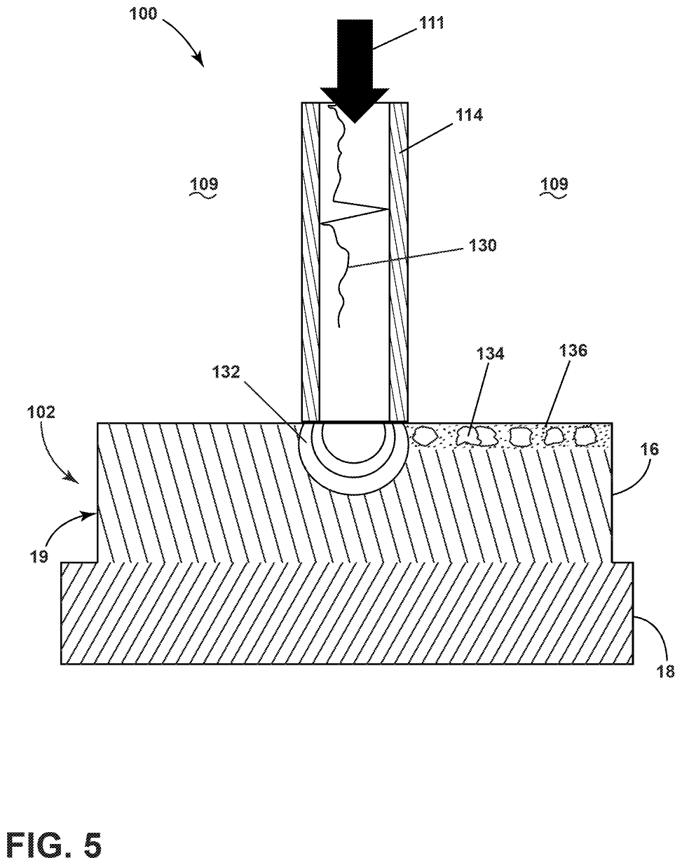

As shown more clearly in the schematic of FIG. 5, the ultraviolet laser 108 essentially emits a laser beam 111 into the high-pressure nitrogen environment, shown generally as 109, above the metal powder shown generally as 136. The metal powder 136 in the example is aluminum and contains silicon carbide 134 particles. The laser beam 111 rapidly heats, efficiently excites and ionizes the pressurized molecules of nitrogen and forms an ionization path of plasma to guide and conduct electric pulses; such a path is the LIPC 114. The LIPC 114 is an electrically conductive and uniform plasma path or channel, which essentially forms a plasma filament. Electric pulses 130 are then applied through the LIPC 114 to the metal powder 136 and silicon carbide 134 particles to efficiently heat and bond the metal powder 136 and silicon carbide 134 to form the AlSiC MMC. The silicon carbide provides reinforcement in the created MMC.

It will be appreciated that the laser beam created by the ultraviolet laser and electric pulse may be applied simultaneously or staggered one after the other, after a short delay. It will also be understood that the laser can be used solely to create the plasma channel for the electrical pulse to pass through and that the electrical pulse is used for the sintering and melting process without the aid of the laser for assisting in the sintering and melting process. In another non-limiting example, the laser can be used as an additional source of heating, or can be used in conjunction with the electric pulse through the LIPC 114.

The aspects of the disclosure result in a higher quality mechanical part made faster and more efficiently than conventional additive manufacturing processes that use a laser to directly heat the metal powder. Conventionally, as a simplified example, for an electric power supply of 120 Watts, a laser power supply having 80 watts and an electric power supply having 40 watts may combine to apply 120 watts of power to a target. Due to the losses associated with converting electrical energy to a laser beam, only approximately 25 percent of the power emitted by the 80 watt laser power supply may be utilized (i.e., 20 watts). When the laser power reaches the target, approximately 70 percent of the 20 watts from the laser is utilized melting the powder; that is, approximately 14 watts of power applied from the 80 watt laser power supply. According to an aspect of the present disclosure, the electric power supply may apply an electric pulse of 40 watts to the LIPC created by the 80 watt laser power supply. Approximately 90% of the 40 watts applied from the electric power supply may be utilized (i.e., 36 watts) at the powder bed. As such, the 36 watts of power from the electric power supply combined with the 14 watts of power from the laser power supply allows for 50 watts of total power to be applied to melt the target in accordance with aspects of the present disclosure.

It has been determined that the creation of the LIPC 114 is dependent on the number of molecules in its path; therefore, the nitrogen 109 is increased within the controlled environment 105 (FIG. 4) until the high-pressure nitrogen environment is achieved to increase the LIPC current. It has also been determined that the measured current increases as the nitrogen pressure increases. Further still, the absorption spectra for nitrogen is significantly better in the ultraviolet spectrum than in the infrared spectrum. For an ultraviolet krypton fluoride laser at 248 nm, the laser photon energy is 5.013 eV, a carbon dioxide infrared laser at 10.6 μm has a photon energy of 0.1173 eV, a nitrogen molecule has an ionization potential of 15.58 eV. The number of photons needed to ionize a nitrogen molecule is approximately four for the ultraviolet laser and approximately 133 for the infrared laser. Thus, additive manufacturing in accordance with present aspects of the disclosure using electric pulses through an ultraviolet induced LIPC apply approximately four times more heat to a target than conventional additive manufacturing methods. Based on the above, the ultraviolet laser provides a significantly more efficient means to create the plasma. In addition, when a high-pressure nitrogen environment is integrated the LIPC current is increased by a factor of 10 when the pressure is increased by 30 psi. The coupled benefit of integrating an ultraviolet laser and a pressurized nitrogen atmosphere produces a significant efficiency increase in producing the LIPC.

Aspects of the present disclosure provide a number of benefits related to additively manufacturing via LIPC using an ultraviolet laser in a nitrogen rich or high-pressure nitrogen environment. Nitrogen rich refers to a level of nitrogen that includes more nitrogen than typical air. In one example, Nitrogen rich can include a pressurized Nitrogen space that replaces typical air or otherwise occupies space around the manufactured asset. Such a process increases the manufacturing process efficiency by more than fifty percent, which increases the rate of manufacturing and lowers cost. Aspects of the present disclosure results in reduced residual stresses due to localized heating. Further still, due to the increase in efficiency with the additive manufacturing process, the boundary layer between dissimilar metals is better controlled by the electric pulse that passes through the LIPC. AlSiC MMC outperform conventional materials, offering improved performance in aircraft components, aircraft structures, and electronics for a variety of applications. The AlSiC MMC produced as disclosed herein features exceptional stiffness and wear resistance, high fatigue strength including two times that of aluminum alloys, high thermal conductivity, and a tailorable coefficient of thermal expansion.

In accordance with the above-described, aspects of the present disclosure provides a three-dimensional additive manufacturing process that may increase reliability of the manufactured part, improve the mechanical properties of parts, and improve efficiency of the selective sintering process. Aspects of the disclosure provide several advantages of using additive manufacturing for three-dimensional metal printing such as, but not limited to, reduced deformation resistance, improved plasticity, simplified processes, increased system electrical energy efficiency, lower cost through improved yield, lowered product defects minimizing voids, and improved affected metal properties. Aspects of the disclosure provide reduced voids and porosity with the conceived possibility of eliminating voids due to the rapid heating provided by the electrical pulses. Improved bonding between SiC particulates and the base metal powder is also achieved. The electric pulses provided through the LIPC disrupts the market as a new offering replacing or reducing the size of more complex and expensive additive manufacturing solutions that use inefficient lasers.

Many other possible configurations in addition to those shown in the above figures are contemplated by the present disclosure. For example, in one non-limiting example, two or more controllers 118 can control the heating process of more than one material during formation. In this aspect, the rate of heating of such materials can be controlled to produce or form additional parts more rapidly, while at the same time reducing the expansion effects of different materials. To the extent not already described, the different features and structures of the various aspects can be used in combination with others as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the invention, including the best mode, and also to enable any person skilled in the art to practice aspects of the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the invention are provided by the subject matter of the following clauses:

1. A method of fabricating an object by additive manufacturing, including providing a molecule rich environment, creating a laser induced plasma channel in the molecule rich environment to a portion of powder in a powder bed, and applying electrical energy to the laser induced plasma channel, wherein the electrical energy is transmitted through the laser induced plasma channel to the powder in the powder bed, wherein energy from at least the electrical energy melts or sinters the portion of the powder in the powder bed.

2. The method of any preceding clause wherein creating the laser induced plasma channel comprises emitting a laser beam from an ultraviolet laser.

3. The method of any preceding clause wherein the molecule rich environment is a nitrogen rich environment.

4. The method of any preceding clause wherein the nitrogen rich environment is a high-pressure nitrogen environment.

5. The method of any preceding clause wherein the powder in the powder bed includes aluminum powder and silicon carbide particles.

6. The method of any preceding clause wherein providing a molecule rich environment comprises supplying nitrogen to a sealed environment until a pressure has increased by 30 psi.

7. The method of any preceding clause wherein the electrical energy is supplied by an electrical power supply.

8. The method of any preceding clause wherein the electrical energy is a set of electric pulses.

9. The method of any preceding clause wherein the energy from the laser induced plasma channel and electrical energy are controlled to contribute to the melting or sintering the portion of the powder in the powder bed simultaneously.

10. The method of any preceding clause wherein the energy from the laser induced plasma channel and electrical energy are controlled to contribute to the melting or sintering the portion of the powder in the powder bed consecutively.

11. An apparatus for additive manufacturing, including an environmental chamber defining an interior, a powder bed within the interior of the environmental chamber, a supply of gas selectively fluidly coupled to the interior of the environmental chamber, an irradiation source irradiating a portion of powder in the powder bed, the irradiation creating an ion channel extending to the powder, and a power source applying electrical energy to the ion channel, the electrical energy being transmitted through the ion channel to the powder in the powder bed.

12. The apparatus of any preceding clause wherein the irradiation source is an ultraviolet laser.

13. The apparatus of any preceding clause wherein the ion channel is a laser induced plasma channel.

14. The apparatus of any preceding clause wherein the power source is an electrical power supply.

15. The apparatus of any preceding clause wherein the electrical energy is an electric pulse.

16. The apparatus of any preceding clause wherein the supply of gas is nitrogen.

17. The apparatus of any preceding clause wherein the environmental chamber is configured to be pressurized with a high-pressure supply of nitrogen.

18. A cooling module, including a metal base plate, and an aluminum silicon carbide metal matrix composite heat spreader unitarily formed with at least a portion of the metal base plate and where the aluminum silicon carbide metal matrix composite heat spreader is configured to be operably coupled to a heat generating electronic device.

19. The cooling module of any preceding clause wherein the metal base plate is an aluminum metal base plate having a set of channels and configured to be liquid cooled.

20. The cooling module of any preceding clause wherein the aluminum silicon carbide metal matrix composite heat spreader is a 3D printed aluminum silicon carbide metal matrix composite heat spreader.

What is claimed is:

1. A method of fabricating an object by additive manufacturing, comprising:
providing a molecule rich environment;
creating a laser induced plasma channel in the molecule rich environment to a portion of powder in a powder bed; and
applying electrical energy to the laser induced plasma channel, wherein the electrical energy is transmitted through the laser induced plasma channel to the powder in the powder bed, wherein energy from at least the electrical energy melts or sinters the portion of the powder in the powder bed.

2. The method of claim 1 wherein creating the laser induced plasma channel comprises emitting a laser beam from an ultraviolet laser.

3. The method of claim 2 wherein the molecule rich environment is a nitrogen rich environment.

4. The method of claim 3 wherein the nitrogen rich environment is a high-pressure nitrogen environment.

5. The method of claim 4 wherein the powder in the powder bed includes aluminum powder and silicon carbide particles.

6. The method of claim 1 wherein providing a molecule rich environment comprises supplying nitrogen to a sealed environment until a pressure has increased by 30 psi.

7. The method of claim 1 wherein the electrical energy is supplied by an electrical power supply.

8. The method of claim 1 wherein the electrical energy is a set of electric pulses.

9. The method of claim 1 wherein the energy from the laser induced plasma channel and electrical energy are controlled to contribute to the melting or sintering the portion of the powder in the powder bed simultaneously.

10. The method of claim 1 wherein the energy from the laser induced plasma channel and electrical energy are controlled to contribute to the melting or sintering the portion of the powder in the powder bed consecutively.

11. An apparatus for additive manufacturing, comprising:
an environmental chamber defining an interior;
a powder bed within the interior of the environmental chamber;
a supply of gas selectively fluidly coupled to the interior of the environmental chamber;
an irradiation source irradiating a portion of powder in the powder bed, the irradiation creating an ion channel extending to the powder; and
a power source applying electrical energy to the ion channel, the electrical energy being transmitted through the ion channel to the powder in the powder bed.

12. The apparatus of claim 11 wherein the irradiation source is an ultraviolet laser.

13. The apparatus of claim 11 wherein the ion channel is a laser induced plasma channel.

14. The apparatus of claim 11 wherein the power source is an electrical power supply.

15. The apparatus of claim 11 wherein the electrical energy is an electric pulse.

16. The apparatus of claim 11 wherein the supply of gas is nitrogen.

17. The apparatus of claim 16 wherein the environmental chamber is configured to be pressurized with a high-pressure supply of nitrogen.

18. A cooling module, comprising:
a metal base plate; and
an aluminum silicon carbide metal matrix composite heat spreader unitarily formed with at least a portion of the metal base plate and where the aluminum silicon carbide metal matrix composite heat spreader is configured to be operably coupled to a heat generating electronic device.

19. The cooling module of claim 18 wherein the metal base plate is an aluminum metal base plate having a set of channels and configured to be liquid cooled.

20. The cooling module of claim 19 wherein the aluminum silicon carbide metal matrix composite heat spreader is a 3D printed aluminum silicon carbide metal matrix composite heat spreader.
